(19) United States
(12) Patent Application Publication
(10) Pub. No.: US 2006/0088351 A1
(43) Pub. Date: Apr. 27, 2006

(54) Residual toner damming assembly

(75) Inventors: Allen J. Thompson, Sodus, NY (US); Willie J. Cottrell JR., Rochester, NY (US); Michael J. Deluzio, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/974,615

(22) Filed: Oct. 27, 2004

(51) Int. Cl. G03G 21/00

(52) U.S. Cl. 399/350

(57) ABSTRACT

A residual toner damming assembly is provided for use in a toner imaging machine having a moving toner image carrying surface and a cleaning blade for removing residual toner particles from the toner image carrying surface. The residual toner damming assembly includes (a) a sealing member for locating against the moving toner image carrying surface upstream of the cleaning blade relative to movement of the moving toner image carrying surface and (b) a damming device located against the sealing member and projecting in a residual toner capturing angle relative to the moving toner image carrying surface for capturing and accumulating a desired quantity of residual toner particles against the moving toner image carrying surface, thereby increasing a number of residual toner particles reaching and lubricating the cleaning edge of cleaning blade against the image carrying surface.

The present invention relates to toner imaging machines, such as xerographic printing machines, and more specifically, to such a machine including a residual toner damming assembly for facilitating cleaning blade lubrication.

The basic principles of electrostatographic printing with dry marking material (hereinafter generally referred to as xerography) are well known: an electrostatic latent image is created on a charge-retentive surface, such as a photoreceptor or other charge receptor, and the latent image is developed by exposing it to a supply of toner particles, which are attracted as needed to appropriately-charged areas of the latent image. The toner particles are then transferred in image-wise fashion from the photoreceptor to a print sheet, the print sheet being subsequently heated to permanently fuse the toner particles thereto to form a durable image.

Following the transfer of the image from the photoreceptor to the print sheet, residual toner particles remaining on the photoreceptor are removed or cleaned by any number of known means, such as including a cleaning blade, brush, and/or vacuum. In a typical embodiment, the removed residual toner is then collected directly into a hopper, from where it is then removed, typically for example by means of an auger, into a waste container.

When a cleaning blade is used to clean the photosensitive surface of the photoreceptor or imaging member, the blade is arranged to wipe but more frequently to scrape such surface in order to effectively remove residual toner. In order to be effective, the cleaning edge of the blade must be pressed against the surface being scraped. If it is pressed too lightly, the residual toner will not be completely scraped off. It must therefore be pressed hard enough against the drum, thereby risking premature wear on the blade and surface due to severe friction forces. In toner imaging machines that run or produce a high volume of copies with few solid toner areas, the quantity of residual toner to be scraped off or removed is ordinarily not sufficient to effectively lubricate the cleaning edge. High frictional forces and squeaking could even result. In any case, such frictional forces act between the photosensitive drum and the cleaning blade in such a way that the surface of the photosensitive drum may be damaged or filming of the toner may result. In addition, stress acting on the blade may deteriorate the desired contact state to cause turning-up of the cleaning edge, and static electricity generated by such friction can result in non-uniform surface potential in the subsequent recharging step of the imaging process.

In order to reduce the frictional force acting between the cleaning blade and the photosensitive drum while maintaining a predetermined pressure of the cleaning blade, it has been conventionally proposed to add a lubricant such as wax to the toner. However, in this case, due to the presence of the lubricant in the toner, fixability of the toner may be degraded or filming may also be caused. This significantly degrades the image quality and renders this proposal impractical.

It has also been known to manually apply a lubricant such as wax on the surface of the photosensitive drum. However, no method has been proposed which is capable of maintaining the thickness of the lubricant film formed on the photosensitive drum for a long period of time within a range of below several hundred angstroms so as not to interfere with the electrostatic characteristics of the photosensitive drum. Attempts have also been made to construct the cleaning blade with a material having a low coefficient of friction. However, these attempts are also subject to the problem of degradation in other characteristics, especially mechanical strength, due to the addition of additives.

Examples of efforts at such suggested solutions can be found in the following references. U.S. Pat. No. 4,519,698 entitled “Image forming apparatus including a cleaning blade and drum lubricant” discloses an image forming apparatus comprises a rotatable photosensitive drum driving mechanism for rotating the photosensitive drum; and a cleaning blade which is capable of being in contact with the outer circumferential surface of the photosensitive drum. The cleaning blade removes a residual developer on the outer circumferential surface upon contact with the drum. A recess is formed at part of the outer circumferential surface and holds lubricant therein; and the tip end of the cleaning blade feeds the lubricant in the recess to part of the outer circumferential surface of the photosensitive drum which is brought into contact with the cleaning blade to form a thin film of the lubricant upon contacting with the lubricant held in the recess as said photosensitive drum is rotated.

U.S. Pat. No. 4,825,249 entitled “Cleaning blade for use with photoelectronic copying machine” discloses an improved cleaning blade for a photoelectronic copying machine. It has a sharp, resilient edge and is superior in wear resistance, and lubricating and cleaning properties. The substrate of the cleaning blade is urethane rubber and is coated with perfluoropolyether having a main structural unit represented by —C.sub.x F.sub.2x —O—(x is 1, 2, 3 or 4) and having an isocyanate, hydroxyl, carboxyl or amino group at least at one end thereof. It may be coated with a mixture of the perfluoropolyether and an isocyanate group or a hydroxyl group.

U.S. Pat. No. 5,450,184 “Cleaning blade for electrophotography, cleaning device for electrophotography, apparatus unit, electrophotographic apparatus and facsimile apparatus” discloses a cleaning blade for electrophotography has a blade body having a rubbery elasticity and a coating layer covering the surface of the blade body. The coating layer is composed of lubricating particles and a binder resin having a lubricability and a wear resistance. The blade body extends parallel to an axis of the latent image support.

When the removal of toners from the photosensitive member by cleaning with a cleaning blade is incomplete, succeeding latent images are formed while the toners remain on the photosensitive member, and thus parts of the formed latent images drop off.

### SUMMARY

In accordance with the present disclosure, there has been provided a residual toner damming assembly is provided for use in a toner imaging machine having a moving toner image carrying surface and a cleaning blade for removing residual toner particles from the toner image carrying surface. The residual toner damming assembly includes (a) a sealing member for locating against the moving toner image carrying surface upstream of the cleaning blade relative to movement of the moving toner image carrying surface and (b) a damming device located against the sealing member and projecting in a residual toner capturing angle relative to the moving toner image carrying surface for capturing and accumulating a desired quantity of residual toner particles against the moving toner image carrying surface, thereby increasing a number of residual toner particles reaching and lubricating the cleaning edge of cleaning blade against the image carrying surface.

### BRIEF DESCRIPTION OF THE DRAWINGS

In the detailed description below, reference is made to the drawings, in which:

FIG. 1 is a simplified elevational view showing relevant elements of toner imaging electrostatographic machine including the residual toner damming assembly of the present disclosure;

FIG. 2 is an enlarged portion of FIG. 1 showing the damming strip of the residual toner damming assembly of the present disclosure;

FIG. 3 is similar to FIG. 1 but showing a start of cleaning in the presence of the residual toner damming assembly of the present disclosure; and

FIG. 4 is an enlarged portion of FIG. 3 showing dammed residual toner lubricating the cleaning edge of the cleaning blade in accordance with the present disclosure.

### DETAILED DESCRIPTION

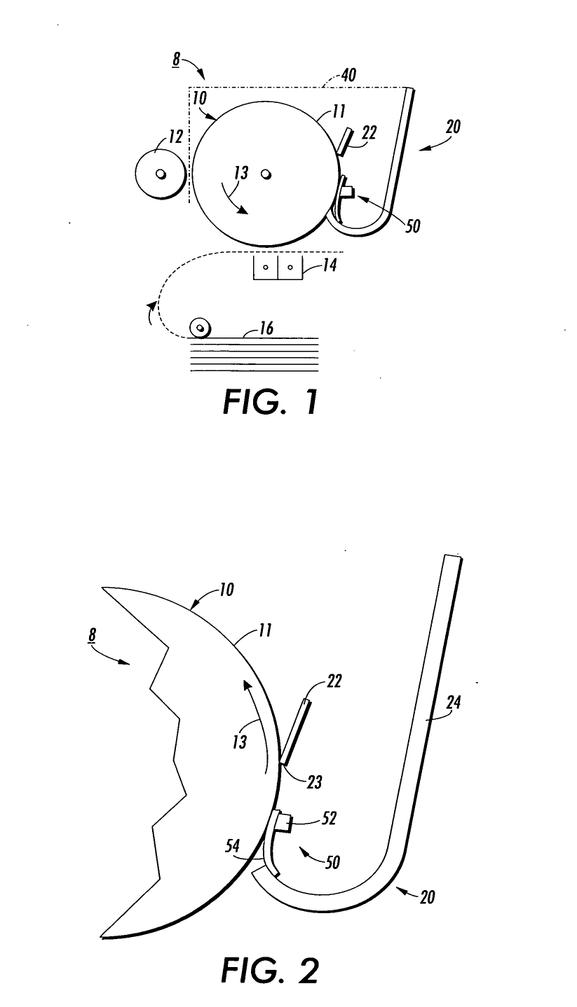

Referring now to FIG. 1, it is a simplified elevational view showing relevant elements of an electrostatographic or toner-imaging machine 8. As is well known, an electrostatic latent image is created, by means not shown, on a surface of a charge receptor or photoreceptor 10. The latent image is developed by applying thereto a supply of toner particles, such as with developer roll 12, which may be of any of various designs such as a magnetic brush roll or donor roll, as is familiar in the art. The toner particles adhere to appropriately charged areas of the latent image. The surface of photoreceptor 10 then moves, as shown by the arrow, to a transfer zone generally indicated as 14. Simultaneously, a print sheet on which a desired image is to be printed is drawn from supply stack 16 and conveyed to the transfer zone 14 as well.

At the transfer zone 14, the print sheet is brought into contact or at least proximity with a surface of photoreceptor 10, which at this point is carrying toner particles thereon. A corotron or other charge source at transfer zone 14 causes the toner image on photoreceptor 10 to be electrostatically transferred to the print sheet. The print sheet is then forwarded to subsequent stations, as is familiar in the art, such as a fuser and finishing devices (not shown). Following transfer of toner image to the print sheet in the transfer zone 14, any residual toner particles remaining on the surface of photoreceptor 10 are removed at a cleaning station 20 that includes the residual toner damming assembly 50 of the present disclosure.

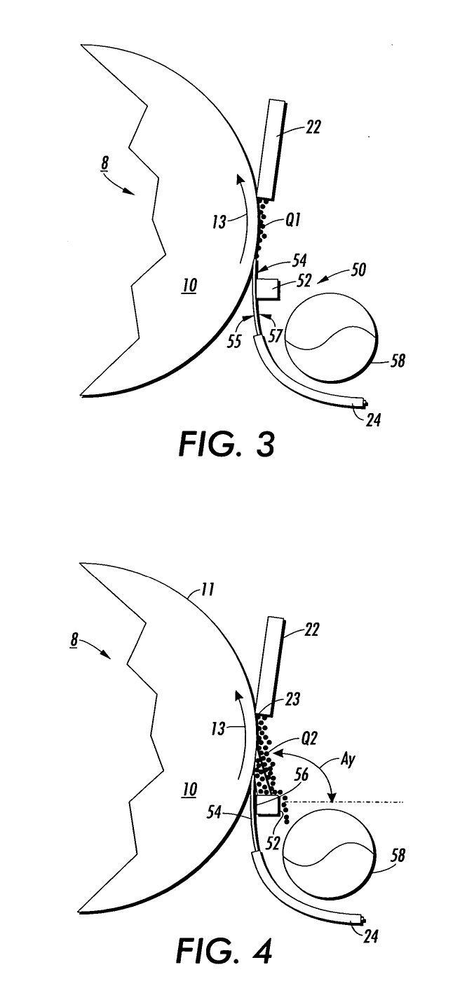

Referring now to FIGS. 1-4, details and aspects of the residual toner damming assembly of the present disclosure are illustrated. As shown, the residual toner damming assembly 50 is suitable for use in a toner-imaging machine 8 having a moving toner image-carrying member 10 including an image-carrying surface 11 that is being cleaned by a cleaning blade 22. The cleaning blade 22 includes a cleaning edge 23 that s mounted in frictional contact with the image carrying surface 11 for scraping and removing residual toner particles from the such surface 11.

The residual toner damming assembly 50 as shown includes a sealing member 54 for locating against the moving toner image carrying surface 11 upstream of the cleaning blade 22 relative to movement 13 of the moving toner image carrying member 10 to remove and ordinarily direct a first quantity Q1 of residual toner away from the surface 11. However, in accordance with the present disclosure, the residual toner damming assembly 50 also includes a damming device 52 that is located against the sealing member 54 and projects in a residual toner capturing angle Ay relative to the moving toner image carrying surface 11 for capturing and accumulating a desired quantity Q2 (greater than Q1) of residual toner particles against the moving toner image carrying surface 11, thereby increasing a number of residual toner particles reaching and lubricating the cleaning blade.

The damming device 52 for example comprises a strip made of a low mass material such as a strip of foam material. The residual toner-capturing angle Ay is generally normal or 900. The damming device 52 for example includes and adhesive backing 56 for attaching it to the sealing member 54. The sealing member comprises a film material and is normally located for directing toner particles overflowing from the damming device 52 into a collection trough 24. The sealing member 54 includes a first surface 55 that is positioned adjacent the toner image carrying surface 11, and a second surface 57 opposite the first surface, and the damming device 52 is attached to the second surface 57 of the sealing member. The damming device 52 is attached to the sealing member 54 for bridging against flow of residual toner particles Q1 moving over the sealing member 54.

The residual toner damming assembly 50 may also include a residual toner collection and augering assembly 24, 58 mounted upstream of the damming device 52 relative to movement 13 of the moving toner image carrying surface 11 for collecting and taking away residual toner particles overflowing the damming device 52.

As shown in the Figures, a cleaning blade 22 is urged against the surface 11 of photoreceptor 10 to scrape the residual toner off the surface 11. The toner, Q, which is thus removed ordinarily, would fall downward into the housing 24 forming a collection hopper. The sealing member, such as a flexible flap seal 54, extending the length of the photoreceptor 10, prevents the removed toner Q1 from escaping the hopper 24. At the bottom of the hopper is the auger 58, here shown end-on. The auger too extends substantially the length of the photoreceptor 10. The auger 58 is rotated and thus conveys toner particles at the bottom of the hopper to a waste container (not shown).

In accordance with the present disclosure, the damming device or strip of foam 52 effectively acts as a dam for holding back the greater amount Q2 of residual toner than would ordinarily stay on the surface 11 after removal by the blade edge 23. This amount 02 of toner is in intimate contact with the surface 11. As the drum 10 rotates some of this quantity Q2 of toner will travel with the drum (back as shown) up into contact with the cleaning edge 23 of the blade 22, thereby greatly increasing cleaning blade lubrication. This quantity Q2 of dammed residual toner is self replenishing and self-depleting, as new residual toner comes from the blade edge 23 into the pile Q2 residual toner in the pile will overflow the height of the damming device above the surface 11 and drop off into the collection hopper 24. In other words, the damming device 52 or strip of adhesive-backed foam that is attached to the sealing member or entrance seal 54 creates a shelf that collects residual toner (Q2) from residual toner falling from the cleaning blade 22. The bank or quantity, Q2 of toner on the shelf accumulates and extends above the top of the entrance seal on the drum surface. The moving drum carries toner from the bank back up to the cleaning blade for lubrication.

As can be seen, there has been provided a residual toner damming assembly for use in a toner imaging machine having a moving toner image carrying surface and a cleaning blade for removing residual toner particles from the toner image carrying surface. The residual toner damming assembly includes (a) a sealing member for locating against the moving toner image carrying surface upstream of the cleaning blade relative to movement of the moving toner image carrying surface and (b) a damming device located against the sealing member and projecting in a residual toner capturing angle relative to the moving toner image carrying surface for capturing and accumulating a desired quantity of residual toner particles against the moving toner image carrying surface, thereby increasing a number of residual toner particles reaching and lubricating the cleaning edge of cleaning blade against the image carrying surface

Although the present invention finds immediate practical use in a cleaning station, it may also be useful in other contexts within xerographic printing, such as in a developing station.

What is claimed is:

1. A residual toner damming assembly for use in a toner imaging machine having a moving toner image carrying surface and a cleaning blade for removing residual toner particles from said toner image carrying surface, the residual toner damming assembly comprising:
(a) a sealing member for locating against said moving toner image carrying surface upstream of said cleaning blade relative to movement of said moving toner image carrying surface; and
(b) a damming device located against said sealing member and projecting in a residual toner capturing angle relative to said moving toner image carrying surface for capturing and accumulating a desired quantity of residual toner particles against said moving toner image carrying surface, thereby increasing a number of residual toner particles reaching and lubricating a cleaning edge of said cleaning blade against said toner image carrying surface.

2. The residual toner damming assembly of claim 1, including a residual toner collection and augering assembly mounted upstream of said damming device relative to movement of said moving toner image carrying surface for collecting and taking away residual toner particles overflowing said damming device.

3. The residual toner damming assembly of claim 1, wherein said damming device comprises a strip made of a low mass material.

4. The residual toner damming assembly of claim 1, wherein said damming device comprises a strip of foam material.

5. The residual toner damming assembly of claim 1, wherein said residual toner capturing angle is generally normal.

6. The residual toner damming assembly of claim 1, wherein said sealing member comprises a film material.

7. The residual toner damming assembly of claim 2, wherein said seal member is located for directing toner particles overflowing from said damming device into a collection trough.

8. The residual toner damming assembly of claim 3, wherein said damming device is attached to said sealing member for bridging against flow of residual toner particles moving over said sealing member.

9. The residual toner damming assembly of claim 3, wherein said damming device includes an adhesive backing for attaching to said sealing member.

10. The residual toner damming assembly of claim 3, wherein said sealing member includes a first surface adjacent said toner image carrying surface, and a second surface opposite said first surface, and said damming device is attached to said second surface of said sealing member.

11. A toner imaging machine, comprising:
(a) a moving toner image-carrying surface;
(b) imaging means for forming a toner image on said moving toner image carrying surface;
(c) a transfer station for transferring said toner image from said moving toner image carrying surface onto a substrate;
(d) a cleaning blade positioned against said toner image carrying surface for removing residual toner particles from said toner image carrying surface; and
(e) a residual toner damming assembly including:
(i) a sealing member for locating against said moving toner image carrying surface upstream of said cleaning blade relative to movement of said moving toner image carrying surface; and
(ii) a damming device located against said sealing member and projecting in a residual toner capturing angle relative to said moving toner image carrying surface for capturing and accumulating a desired quantity of residual toner particles against said moving toner image carrying surface, thereby increasing a number of residual toner particles reaching and lubricating a cleaning edge of said cleaning blade against said toner image carrying surface.

12. The toner imaging machine of claim 11, including a residual toner collection and augering assembly mounted upstream of said damming device relative to movement of said moving toner image carrying surface for collecting and taking away residual toner particles overflowing said damming device.

13. The toner imaging machine of claim 11, wherein said damming device comprises a strip made of a low mass material.

14. The toner imaging machine of claim 11, wherein said damming device comprises a strip of foam material.

15. The toner imaging machine of claim 11, wherein said residual toner capturing angle is generally normal.

16. The toner imaging machine of claim 11, wherein said sealing member comprises a film material.

17. The toner imaging machine of claim 12, wherein said seal member is located for directing toner particles overflowing from said damming device into a collection trough.

18. The toner imaging machine of claim 13, wherein said damming device is attached to said sealing member for bridging against flow of residual toner particles moving over said sealing member.

19. The toner imaging machine of claim 13, wherein said damming device includes and adhesive backing for attaching to said sealing member.

20. The toner imaging machine of claim 13, wherein said sealing member includes a first surface adjacent said toner image carrying surface, and a second surface opposite said first surface, and said damming device is attached to said second surface of said sealing member.
